(19) United States
(12) Patent Application Publication
(10) Pub. No.: US 2020/0319658 A1
(43) Pub. Date: Oct. 8, 2020

(54) WIDE RANGE. LOW FLOW RATE OF DECAY, TEMPERATURE DETERMINATION FLOW CONTROLLER

(71) Applicant: FLOW DEVICES AND SYSTEMS INC., Yorba Linda, CA (US)

(72) Inventors: Bhushan SOMANI, Yorba Linda, CA (US); Christophe ELLEC, St. Petersburg, FL (US)

(73) Assignee: FLOW DEVICES AND SYSTEMS INC., Yorba Linda, CA (US)

(21) Appl. No.: 16/758,031

(22) PCT Filed: Oct. 25, 2018
(86) PCT No.: PCT/US2018/057610

§ 371 Date: Apr. 21, 2020

Related U.S. Application Data
(60) Provisional application No. 62/577,101, filed on Oct. 25, 2017.

(51) Int. Cl. G05D 7/06; G01F 1/88; G01F 15/00; G01F 1/40

(52) U.S. Cl. CPC G05D 7/0688; G01F 1/40; G01F 15/005; G01F 1/88

(57) ABSTRACT

Mass flow control methods and systems are described enabling rate of decay measurements with an orifice (or flow restrictor) located between the control volume and the outlet valve such that the outlet valve acts as the valve restricting backpressure. The system may include a main flow path and a reduced flow path that split the gas flow based on the received set point and backpressure. Measuring valve coil temperature may be used by measuring voltage and current of the valve of known resistance at room temperature and using copper coefficient of thermal resistivity delta. This temperature data may improve adjacent transducer temperature data and adjust the transducer output. Flow calculation during a long ROD pressure drop (in reduced flow rate) by making smaller flow calculation during sub section of the same, adjusting the control loop of delivered flow in real time while the ROD is still going and repeating.

### CROSS-REFERENCE & PRIORITY CLAIM

This application claims the benefit of U.S. Provisional Application No. 62/577,101 filed Oct. 25, 2017 entitled “Wide Range, Low Flow Rate of Decay, Temperature Determination Flow Controller” which is incorporated herein by reference in its entirety.

### DESCRIPTION

Various embodiments relate to gas and fluid mass flow control methods, systems and apparatuses that are capable of calculating rate of a decay measurements. Fluid as used herein is intended to encompass materials which are in a gaseous phase because of specific combinations of pressure and temperature despite whether such materials are gaseous under everyday circumstances. Thus, fluids may include, for example, water vapor or boron trichloride (BCl₃), as well as common gaseous materials such as silane (SiH₄), argon and nitrogen. In particular, exemplary embodiments relate to determining the present flow conditions at a flow restriction in a fluid flow pathway to ascertain whether or not a chosen flow control algorithm is valid for those conditions. Based on such calculations, the instant flow control algorithm may be corrected or changed as appropriate.

### SUMMARY

Various embodiments include a flow control system that comprises one or more sensors, a flow measurement sensor that comprises one or more sensors. A self-correcting pressure-based mass flow control apparatus may comprise a flow control portion and a flow verification portion within the same device.

In some embodiments, the orifice (or flow restrictor) may be located between the control volume and the outlet valve such that the outlet valve acts as the valve restricting backpressure deliberately causing flow to go into non-sonic regime and thus responding faster to a step-down response. Simultaneously, the inlet valve may be configured to perform a rate of decay operation but the device may not be configured to measure actual flow in a delta P mode.

In other embodiments, a method for measuring valve coil temperature may be used by measuring voltage and current though a copper wire of known resistance at room temperature and using copper coefficient of thermal resistivity change. This temperature data can be used to improve adjacent transducer temperature data and adjust the output signal of the transducer.

Other embodiments include, a mean of calculating flow during a long ROD pressure drop (especially with reduced flow rate) by making smaller flow calculation during sub section of the same, adjusting the control loop of delivered flow on the fly while the ROD is still going and repeating.

Various embodiments are directed to determining the temperature variances in a fluid flow path, in order to determine the variance in the transducer measured temperature compared to the temperature measured in the solenoid since solenoids can get heated in operations. Exemplary embodiments disclose a method of determining the temperature of the solenoid by using the change in resistivity of the metal in the solenoid. The solenoid may be composed of a material that exhibits a change in resistivity based on a change in temperature. Various materials exhibit the above stated properties, for example, copper, alloys, hastealloy, etc. In various embodiments, upon determining a variance between the solenoid temperature that may be located upstream or downstream from a temperature measuring transducer, the gas deliver process may be modified. Some modifications of the gas delivery process may include changing the setting of another solenoid in the flow path to change the pressure at one or more transducers in order to compensate for the change in temperature of the gas. In some embodiments, the gas delivery process may be paused until the temperature variance is reduced. A non-limiting example of such a method is provided in the flow diagram of FIG. 7, steps 710-760.

In other embodiments, the mass flow controller may receive a very low flow rate set point and the outlet of the mass flow controller may receive back pressure from the chamber of the tool at the same time. In the condition described above, the mass flow controller may find it challenging to flow the gas accurately. In the embodiments described below, the mass flow controller may perform a long rate of decay operation such that the inlet valve is closed with gas filled in the reference volume permitted to bleed out. The verification module of the mass flow controller may perform repeated rate of decay calculations as the gas bleeds out of the reference volume. A proportional control valve such as a solenoid or piezo type of valve would then adjust the pressure to a pressure transducer measuring the pressure of the gas as it flows by may be adjusted to change the pressure at P1 (FIG. 2) along the pressure/flow calibration curve. The repeated rate of decay calculation will permit the mass flow controller to determine the pressure drop as a function of time in order to operate within the calibration curve while delivering a near constant or constant flow rate of gas. A non-limiting example of such a method is provided in FIG. 8, steps 810-860.

In yet another embodiment, the flow path from the reference volume to the outlet may be split into two separate flow paths (main flow path and reduced flow path). In various embodiments, when the mass flow controller received a set point that is below the previously set high threshold (e.g. about 1% to about 9% of maximum flow rate of the mass flow controller) for the reduced flow path, the mass flow controller may flow the gas entirely through the reduced flow path. In other embodiments, when the set point is higher than the lowest threshold flow path (e.g. about 9.1% to about 110% of the maximum flow rate) the mass flow controller may flow the gas entirely through a combination of the reduced flow path and main flow path. In other embodiments, if the set point is higher than the highest threshold (e.g., about 9%), then the control module may choose to use the reduced flow path and the main flow path. In yet another embodiments, if the set point is higher than the highest threshold (e.g., about 9%) of the reduced flow path, then the control module may use only the main flow path. In yet another embodiment, if the set point is higher than the main flow path (e.g. >91%), then control module will use both flow paths.

A method for controlling a mass flow control apparatus, the method comprising providing a main fluid flow path for flowing a gaseous fluid, closing a shutoff valve in the main flow path upstream from a flow restrictor, performing multiple pressure measurements, periodically, of the fluid downstream from the fluid restrictor, perform multiple temperature measurements of the fluid downstream from the fluid restrictor, and performing multiple rate of decay measurements in the main flow path using the temperature and pressure measurements at different time intervals. The method for controlling a mass flow control apparatus may further include providing a main fluid flow path for flowing a gaseous fluid connected to a reduced flow path, closing an inlet valve in the main flow path upstream from the reduced flow path, performing multiple pressure measurements of the fluid downstream from the inlet valve, performing multiple temperature measurements of the fluid downstream from inlet valve, calculating a flow rate during a long rate of decay pressure drop by making smaller flow calculation along the reduced flow path connected to the main flow path, and repeatedly adjusting the control loop of fluid flow, while the rate of decay is still going.

A method for controlling a mass flow control apparatus, the method includes providing a flow path for flowing a gaseous fluid, measuring a pressure value of the gaseous fluid in the flow path downstream to a flow restrictor periodically by a pressure sensor, measuring a first temperature using a temperature sensor of the gaseous fluid in the flow path downstream to a flow restrictor, activating a shutoff valve in the flow path upstream from the flow restrictor, measuring a valve coil temperature by measuring voltage and current though a copper wire of known resistance at room temperature, using copper coefficient of thermal resistivity change, the temperature data can be used to improve adjacent transducer temperature data and adjust the output signal of the transducer to form a rate of decay measurement in the flow path using the measured pressure values and temperature values at different periods.

A system including a main fluid flow path connected to a reduced fluid flow path comprising a flow restrictor, an inlet valve connected to the flow path, at least one transducer located downstream from the inlet valve and connected to the main flow path, a shut off valve, located downstream from inlet valve and connected to the main flow path and a control module, the control module is configured to calculate flow rate from the pressure signal from the at least one transducer when the inlet valve is closed and adjust the shut off valve to adjust the flow rate through the flow restrictor. The system includes the inlet valve, the shutoff valve, or both comprise solenoid valves. The control module comprises a long rate of decay sub-module configured to continuously calculate flow rate based on the at least one transducer pressure signals and compare said signals to a preset flow value at a location along the reduced flow path. The control module is configured to continuously shut the inlet valve to calculate a rate of decay. The control module is configured to shut the inlet valve, measure the rate of decay along the reduced flow path, and adjust the shutoff valve, every 50-300 milliseconds. The control module may continuously calculates rate of decay based on the at least one transducer signal and the pressure at the flow restrictor. The control module is configured to measure the resistance change of the solenoid component of the inlet or shutoff valve over at least one time interval to calculate the change in temperature of the solenoid. The control module is configured to compare the temperature change of the solenoid with the temperature change data from a transducer adjacent to the solenoid, and determine the difference in reported temperatures. The system may include applying a correction value to the transducer recorded temperature based on the difference with the solenoid temperature. The system may use a reduced flow path inlet is in fluid communication with the main flow path downstream from the inlet valve.

In various embodiments, a system for gas flow control may include a main fluid flow path and flow restrictor located along said main flow path, an inlet valve connected to the main flow path, at least one transducer located downstream from the inlet valve and connected to the main flow path, a shut off valve, located downstream from inlet valve and connected to the main flow path, a control module, and the control module is configured to close the shutoff valve, perform temperature and pressure measurements of the fluid downstream from the fluid restrictor, the system may perform multiple rate of decay measurements in main flow path using the temperature and pressure measurements at different time intervals.

### BRIEF DESCRIPTION OF DRAWINGS

The disclosure will become more fully understood from the following detailed description, taken in conjunction with the accompanying figures, wherein like reference numerals refer to like elements, in which:

FIG. 1A is a schematic diagram of a flow control system, according to an exemplary embodiment.

FIG. 1B is a schematic diagram of a flow control system, similar to FIG. 1A.

FIG. 2 is a schematic diagram of a flow control system, according to another exemplary embodiment.

FIG. 3 is a diagram of a flow control system, according to an exemplary embodiment.

FIG. 4 is another schematic diagram of a flow control system in accordance with an exemplary embodiment.

FIG. 5 is a conceptual representation of a mass flow controller in accordance with an exemplary embodiment.

FIG. 6 is a flow diagram for measuring rate of decay in accordance with an exemplary embodiment.

FIG. 7 is a flow diagram for a process in accordance with an exemplary embodiment.

FIG. 8 is a flow diagram for a process in accordance with an exemplary embodiment.

### DETAILED DESCRIPTION

This disclosure is not limited in its application to the details of construction and the arrangement of components set forth in the following description or illustrated in the drawings. The system is capable of other embodiments and of being practiced or of being carried out in various ways. Also, the phrasing and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. The use of directional adjectives “inner, “outer,” “upper,” “lower,” and like terms, are meant to assist with understanding relative relationships among design elements and should not be construed as meaning an absolute direction in space nor regarded as limiting. As used herein the terms “module” or “sub-module” comprise electronic components as well as circuitry, in addition to applications stored on a storage medium and executable on a processor. Examples include, but are not limited to, electronic circuitry, components and applications configured to perform flow decay calculations, communicate with one or more transducers and actuate one or more valves.

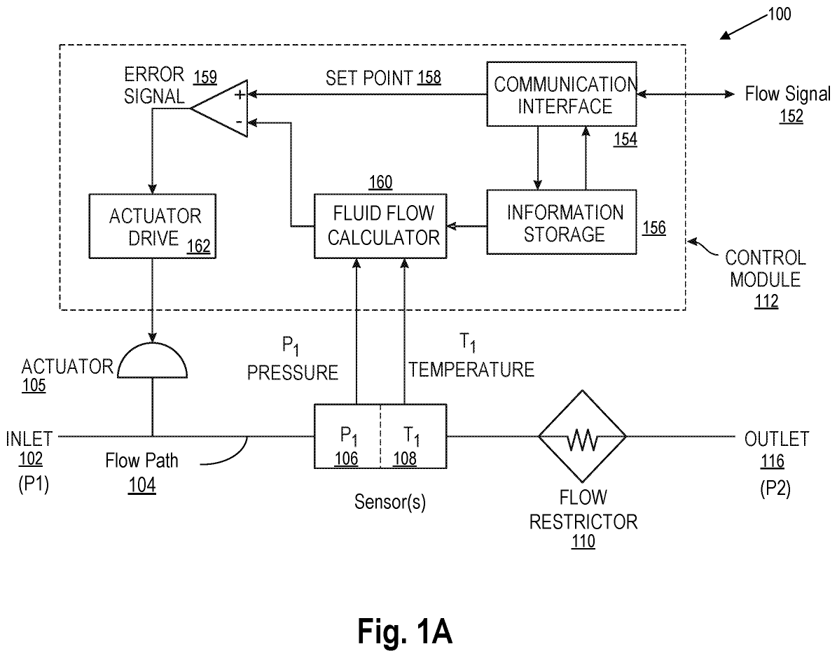

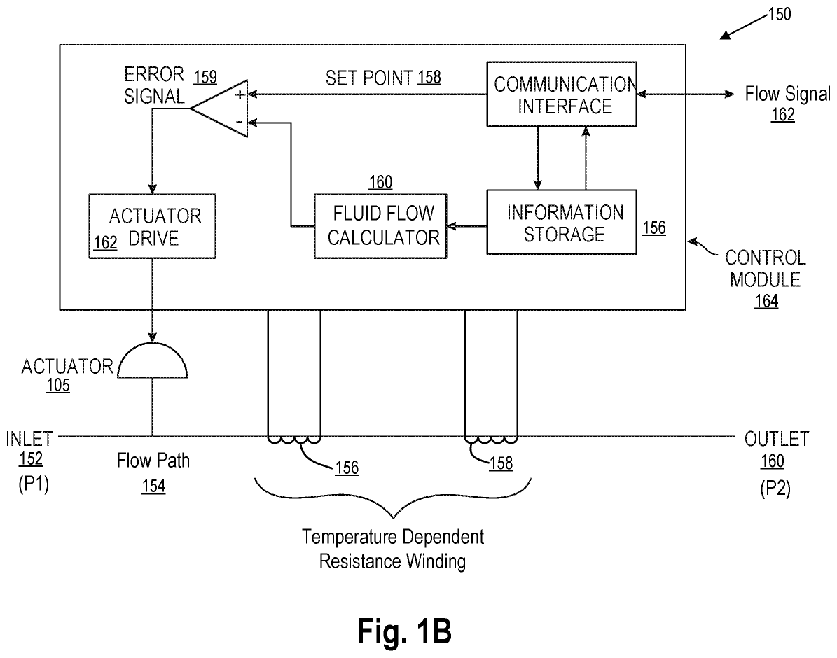

In an exemplary embodiment, the mass flow controller may include an inlet filter, an inlet regulator (valve), a pressure and temperature sensor, a control volume, an outlet sensor, an outlet regulator and an outlet orifice with filter. Further for specific temperature and pressure measurements the mass flow controller includes a solenoid valve and a transducer. Referring to FIG. 1A, an exemplary mass flow controller system 100 is shown where the control module 112 receives signals from the pressure sensor 106 and temperature sensor 108 located downstream from the inlet valve 102 of the fluid conduit (flow path) 104. Accordingly, pressure P1 at the inlet valve 102 and pressure P2 at the outlet valve 116 may be measured and used for calculation at the fluid flow calculator sub-module 160 of the control module 112. In particular, flow rate at the flow restrictor 110 can be measured at various time intervals as further described below. Additionally, the control module 112 may store or retrieve information from the information storage sub-module 156, which is in communication with the communication interface sub-module 154. The control module 112 permits determining a set point 158 which may be adjusted based on the error signal 159 component before used by the actuator drive 162 to drive the actuator 105 controlling the inlet valve. As shown, the control module 112 is also configured to receive or output flow signal 152.

FIG. 1B shows a similar exemplary control system 150 where the flow path 154 comprises temperature dependent resistance windings 156 and 158 connected to the circuitry of the control module 164. Here the temperature responsive elements 158 may be arranged such that heat transfer caused by a fluid moving through the conduit 154 may be measured and a corresponding mass flow calculated. This exemplary embodiment may be further understood or modified in accordance with present disclosure. For instance, the control module 164 may further comprise multiple valves (not shown) and rate of decay sub-module(s) (not shown) for calculating decay along the flow path 154.

In an exemplary embodiment, a system, comprises (a) a fluid flow path connected to a reduced flow path comprising a flow restrictor; (b) an inlet valve connected to the flow path; (c) at least one transducer located downstream from the inlet valve and connected to the flow path; (d) a shut off valve, located downstream from inlet valve and connected to the flow path; and (e) a control module. One or more of the valves may be solenoid valves. Moreover, the system may comprise a plurality of valves and transducers. As such, temperature and pressure signals may be obtained at various points along the flows path. In some instances, it may be desirable to measure flow rate when the inlet valve is shut, for example to calculate rate of decay. This can be challenging if there is back pressure or flow through the reduced flow path is not sufficient for rate of decay calculations. Accordingly, the control module can be configured to calculate flow rate from the pressure signal from the at least one transducer when the inlet valve is closed and adjust the shut off valve to adjust the flow rate through the flow restrictor.

The control module may specifically comprise a long rate of decay sub-module configured to continuously calculate flow rate based on the at least one transducer pressure signals and compare said signals to a preset flow value at a location along the flow path. This measurement may be done with a feedback loop, where the inlet valve is continuously open and shut to perform multiple rate of decay calculations. In a non-limiting example, the control module may be configured to shut the inlet valve, measure the rate of decay along the flow path, and adjust the solenoid valve, every 50-300 milliseconds to control the pressure P1 to maintain a flowrate using a pre-calculated calibration curve. More specifically, the measurements may be made based on transducer signals and the pressure at the flow restrictor.

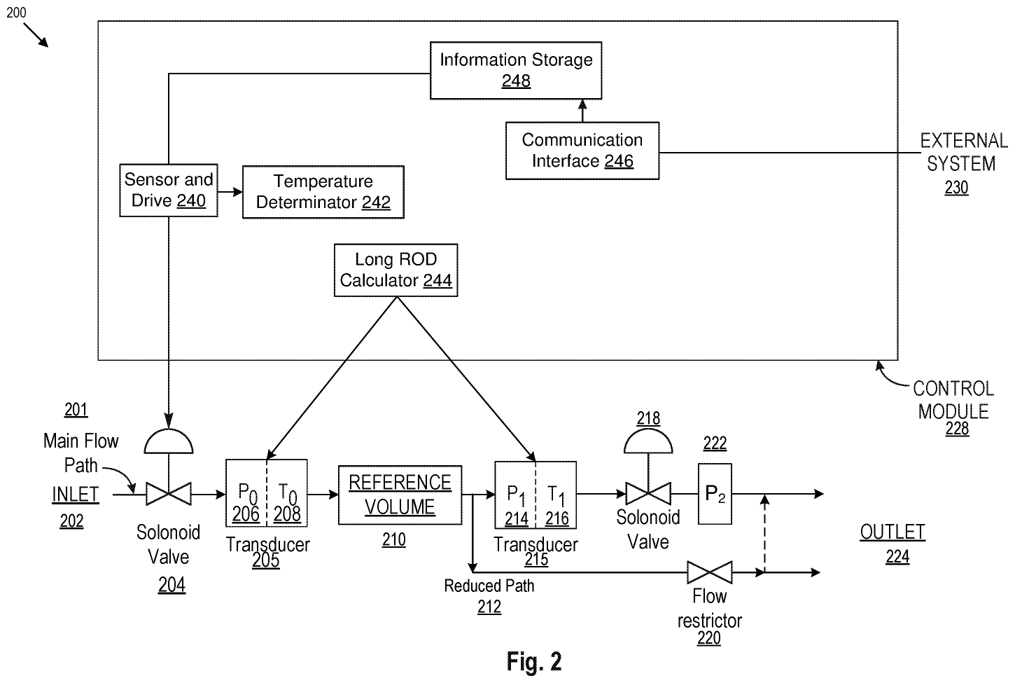

An exemplary system is provided in FIG. 2, which illustrates a schematic of a mass flow control system 200. Here, an inlet 202 for a gaseous fluid leads the gaseous fluid through a solenoid valve 204, a reference volume 210, and transducers 205 and 215. The gaseous fluid gets partitioned from the main flow path 201 in order to facilitate reduced flow rate set points by the gaseous flow path (reduced flow path) 212. In various embodiments, methods and apparatus for a dual flow path with dual outlets mass flow controller. A gaseous liquid flowing through a mass flow controller is partitioned at the exit to follow a dual flow path (main flow path 201 and reduced flow path 212). The gaseous liquid exiting is partitioned in a ratio ranging between 1%, 2%, 3%, 4%, 5%, 6%, 7%, 8% and 9% of the original flow through a narrower reduced flow path 212 with a narrower tube that may be, but is not limited to, hagen-poisulle tube, a thermal sensor or a flow restrictor 220. As shown in FIG. 2, a secondary smaller reduced flow path 212 that is configured to flow parallel to the main flow path 201 may be used during reduced flow scenarios. As shown in FIG. 2 the reduced flow path 212 may be used when the MFC receives a request to transfer at a rate less than 9% of full specification. The larger flow path may not be used until there is a set point larger than or equal to 10% of full specification. The main flow path 201 is capable of providing about 91% or less of the maximum flow rate of the mass flow controller

In other embodiments, a long rate of decay may be implemented when the MFC received a very low flow rate set point. In other embodiments, the mass flow controller may receive a very low flow rate set point and the outlet of the mass flow controller may receive back pressure from the chamber of the tool. In the condition described above, the mass flow controller may find it challenging to flow the gas and perform a rate of decay calibration. In the embodiments described below, the mass flow controller may perform a long rate of decay operation such that the inlet valve is closed with gas filled in the reference volume permitted to bleed out. The control module of the mass flow controller may perform repeated rate of decay calculations as the gas bleeds out of the reference volume. Since the flow rate may be reduced due to the back pressure, a solenoid valve that is located between the pressure transducer measuring the pressure of the gas as it flows by may be adjusted to change the pressure at P1 (FIG. 2) along the pressure/flow calibration curve. The repeated rate of decay calculation will permit the mass flow controller to determine the pressure drop as a function of time in order to operate within the calibration curve while delivering a near constant or constant flow rate of gas.

A required amount of gas is passed through a solenoid 204, thereafter one or more of the transducers (205, 215) measure pressure and temperature of the gas through the gas flow path 201. The temperature and pressure are measured periodically while the inlet valve is shut every 50-300 m-secs to monitor the rate of decay of the gas along the flow path using long rate of decay calculator sub-module 244 of the control module 228. The consecutive pressure and temperature measurements values along the path of the gas flow path with time provide a rate of decay of the gas through the gas flow path. After determining a rate of decay at the periodic interval the rate of decay may be used to adjust the P1 214. In some embodiments, this process may be used repeatedly during a single inlet shutoff the adjust P1 214 multiple times. The system 200 may include a means for performing multiple calculations ad different points of the flow path. For instance it may calculate flow during a long rate of decay (ROD) pressure drop (especially with reduced flow rate) by making smaller flow calculation along the reduced flow path (212), particularly at the flow restrictor 220, and adjusting the control loop of delivered flow on the fly while the ROD is still going and repeating.

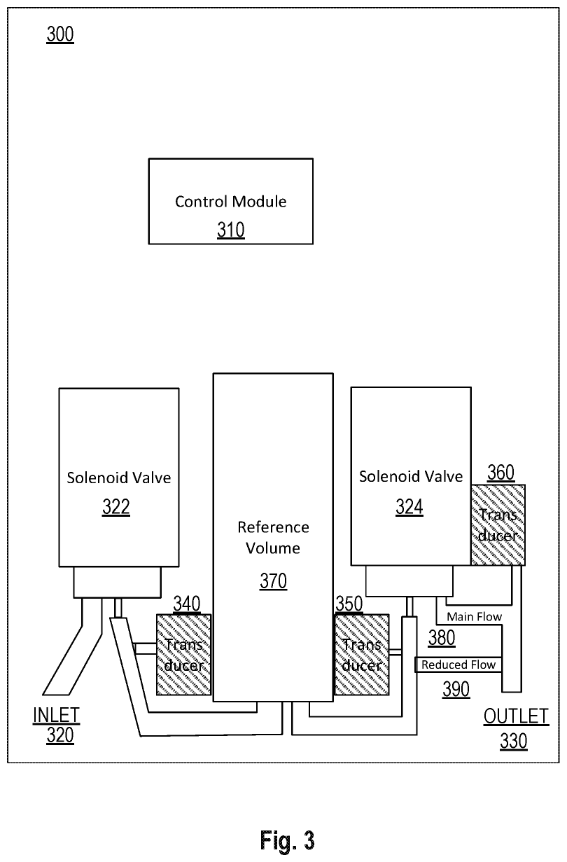

FIG. 3 provides yet another exemplary system. Here, the system 300 comprises a control module 310 and a flow path having an inlet 320 controlled by an inlet solenoid valve 322 and an outlet 330 controlled by an outlet solenoid valve 324. Temperature and pressure may be measured at the transducers 340, 350 and 360. In particular, a reduced flow path 390 may branch off the main flow path 380. As such the rate of decay calculation of gas flow over either reduced flow path 390 or main flow path 380 may be made by the control module.

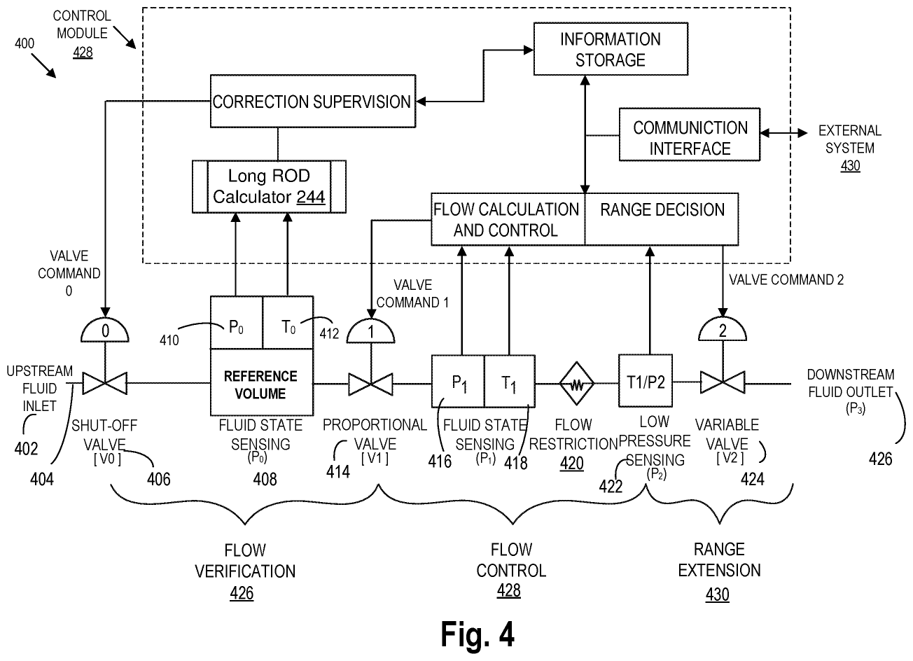

FIG. 4 provides yet another exemplary embodiment where rate of decay may be measured. Here, the main flow line 404 is connected to a shut-off valve 406, proportional valve 414 and variable valve 424 as well as a flow restrictor 420. A valve upstream from the flow restrictor 420 may be shut off to initiate flow decay measurements with the control module 428. In particular, a decay measurement sub-module (not shown) may obtain temperature and pressure data from one or more of the sensors/transducers (e.g. 410, 412, 416, 418 or 422) to calculate rate of decay and accordingly adjust one or more of the valves to adjust flow rate.

FIG. 4 is a schematic of a mass flow controller 400 that includes a flow verification capability while using a pressure-based flow sensor. The mass flow controller 400 may comprise (in upstream to downstream flow sequence) a fluid inlet 402, to a fluid pathway 404, a controllable shutoff valve 406, provisions for measuring a reference temperature 412 (T0) and a reference pressure 410 (P0) of a fluid contained within a reference volume 408 of the fluid conduit 404, a proportional control valve 414, provisions for measuring a first temperature 418 (T1) and a first pressure 416 (P1) of the fluid contained within the fluid pathway upstream of a flow restriction 420, provisions for measuring a second pressure 422 (P2) of the fluid contained within the fluid pathway downstream of the flow restriction 420, a variable valve 424, and an outlet 426 from the fluid pathway 404. Knowing the aggregate volume of fluid contained within the reference volume 408, plus any directly connected fluid conduit 404 between the shutoff valve 406 and the proportional valve 414, enables flow verification (self-calibration) of the embodiment mass flow controller 400. Flow verification method includes closing the shutoff valve 406 to isolate the fluid conduit 404 from the inlet 402 while controlled mass flow continues through the outlet, making repeated measurements of the reference temperature 410 (T0) and the reference pressure 412 (P0) of the fluid contained within the reference volume 408 of the fluid conduit 404 for a period of time, and repeatedly measuring the rate of decay of the gas while adjusting the flor restriction 420 to control the pressure P1 at pressure sensor 416. Calculating a verified flow signal using pressure-volume-temperature (PVT, also known as Rate Of Fall, RoF) methods related to the aggregate volume of fluid, and providing the verified flow signal to a supervision function (control module 428). The control module 428 may subsequently choose whether to enable additional self-calibration processes, change a system parameter, merely store the results, or take other actions. For example, the control module 428 may direct that a series of flow verification measurements be performed corresponding to different values of determined fluid pressures (P1, P2) and fluid temperature (T1) adjacent the flow restriction 420. This series of flow verification measurements readily determines a calibration curve, for a discrete flow restriction, based at least in part upon the verified flow signals. It should be noted the control module 428 does not require any particular critical ratio (P1/P2) be maintained between the determined upstream (P1) and downstream (P2) pressures when a known calibration curve is obtained. The known calibration curve may be entirely empirical or conform to a theoretical model. The long ROD process described herein permits the mass flow controller to flow very low flow rates such as less than about 2% of maximum flow rate into a back pressure environment. In an exemplary embodiment, methods, systems and apparatuses for a long rate of decay of measurements of a gas in a mass flow controller comprise obtaining measurements at least one solenoid valve.

Generally, a solenoid valve may be made of an inner metallic jacket and an outer metallic jacket. The metallic jacket may be made from a metal including, but not limited to, copper, silver or aluminum. Essentially any solenoid material and configuration which permits gas flow therethrough is contemplated herein. In certain instances the solenoid valve exhibits substantially the same temperature as the gas flowing through the flow path. Similarly, the solenoid valve may exhibit substantially the same temperature as one or more transducer(s) positioned along the flow path. Accordingly, the temperature of the solenoid valve may be used, for example, as a proxy for the gas or transducer temperature, or compared directly against the temperature of the gas or a transducer(s) at a different point along the flow path. Additionally, it may be used to compare the temperature between the gas and a transducer(s) or between different transducers, at different points along the flow path.

Thus in an exemplary embodiment, based on the known coefficient of resistivity of the metal at a given temperature (for example, room temperature) which maybe provided by the manufacturer and stored in the information storage, obtained from literature or measured, the change in the resistance of the solenoid may be used determine the temperature of the solenoid. The relationship between voltage, resistance and current may be used to perform this type of calculation. For instance, at a first temperature (T1) the resistance (R1) is equal to the voltage (V1) divided by the current (I1). At another temperature (T2) the Resistance (2) is again voltage (V2) divided by current (I2). R1 may be measured at the factory while R2 calculated in the field by measuring V2 and I2. Accordingly, the change in the resistivity (Δr) is the change in temperature (ΔT) multiplied by the thermal coefficient of resistance of the solenoid (e.g. Copper ˜0.4%/° C.). Accordingly, in some embodiments, the resistance is measure to have changed by 2%, then the temperature may have changed by 5° C. In some embodiments, a precalculated temperature to change in resistance calibration curve may be stored in the information storage so that it is efficient to determine the change in the temperature.

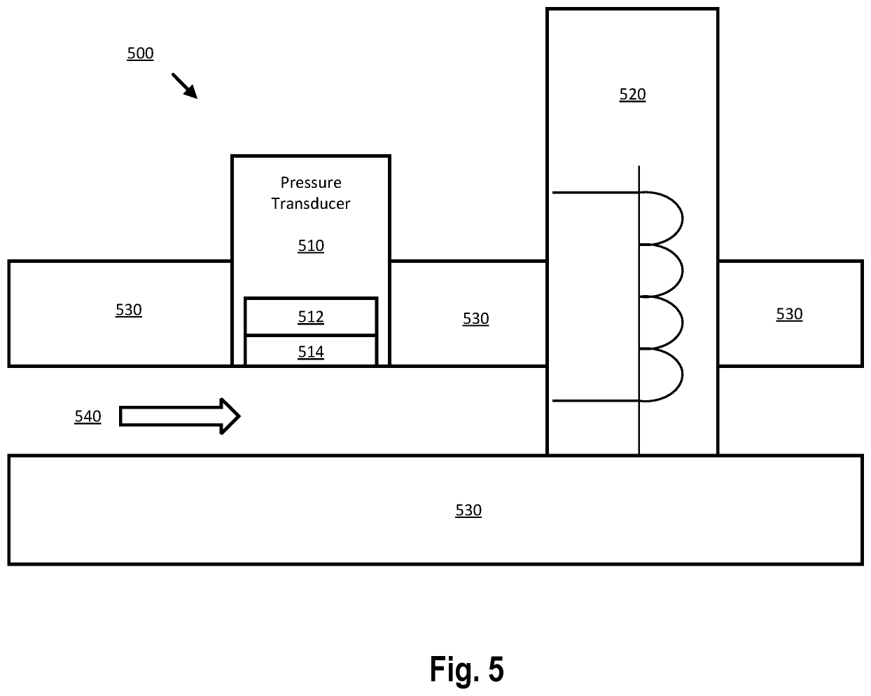

This technique may be further understood in view of the conceptual representation provided in FIG. 5. As shown, the device 500 comprises a mass flow controller body (MFC) 530 through which a gas 540 flows in the direction of the arrow. It should be noted that the flow may be in reverse direction depending on the configuration of the components. A pressure transducer 510 which may comprise a temperature element 512 and a pressure element 514 is positioned along the flow path. The device 500 may measure voltage and current using electronic circuit on the printed circuit board. Here, the change in the resistivity of the solenoid valve 520 placed along the flow path may be determined by passing voltage and current though the metal solenoid valve 520. The temperature of the solenoid valve 520 and hence the gas passing through it may be determined by determining the resistance of the metal jacket of the solenoid as previously explained. The solenoid temperature may be compared to the temperature determined by the transducer 510 that is positioned along the flow path near the solenoid 520. Devices contemplated according to these exemplary embodiments, may comprise a plurality of transducers and solenoid valves. As such, the calculations may involve measurements from many different components at different positions along the flow path.

Advantageously, transducer temperature signals may be verified using the temperature of the solenoid as a reference. In particular, the transducer signal may be corrected on an iterative basis as temperature data is constantly collected from the solenoid and compared with that of the transducer(s). Alternatively, a correction value for one or more transducers may be calculated to obtain a more accurate reading. As yet another advantage, the exemplary embodiments permit incorporation of further safety features into mass flow controllers and systems. For instance, when the measured temperature of the solenoid deviates from the measured temperature of the transducer by more than 5° C. the MFC may activate an alarm and additionally pause or terminate gas processing. In additional non-limiting examples, if the temperature of the gas is determined to be less or more than the required temperature by 1 or 2.5 or 3.5 or 5 degrees, an alarm may be initiated to inform the operator or for the system to automatically shut down the gas flow so as to avoid any undesirable effects.

The exemplary embodiments provide for methods of performing decay calculations as well as adjusting flow rates based on such calculations. For instance, in an exemplary embodiment, a method comprises (a) providing a main fluid flow path for flowing a gaseous fluid, (b) closing a shutoff valve in the main flow path upstream from a flow restrictor, (c) performing multiple pressure measurements of the fluid downstream from the fluid restrictor, (d) perform multiple temperature measurements of the fluid downstream from the fluid restrictor, and (e) performing multiple rate of decay measurements in main flow path using the temperature and pressure measurements at different time intervals. The rate of decay measurements may be used to modify the flow rate by adjusting one or more of the valves along the main flow path.

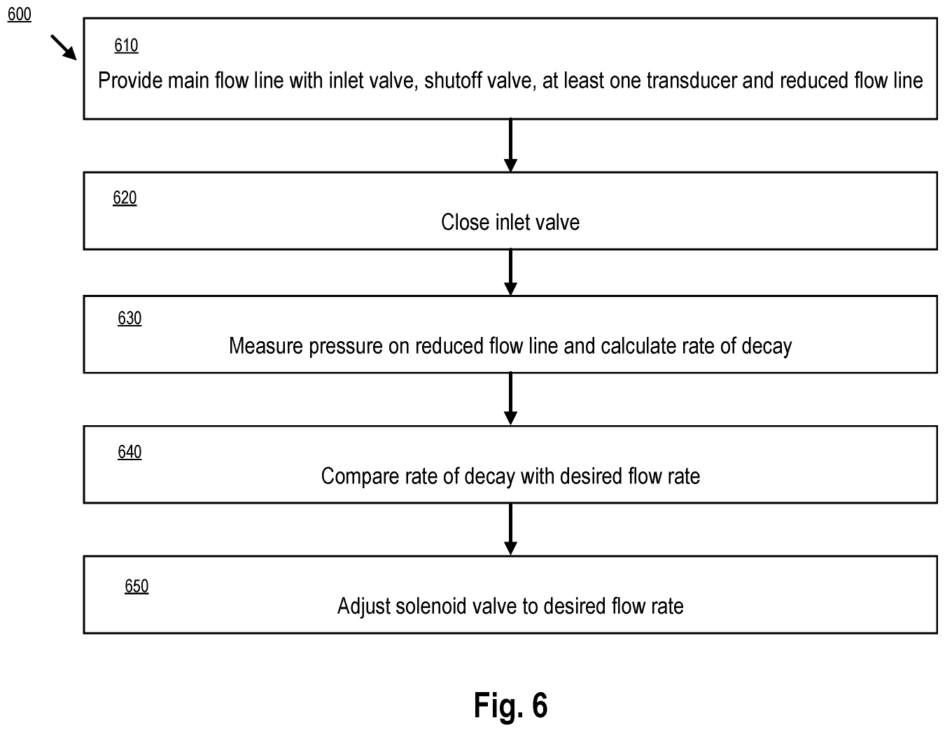

The flow diagram in FIG. 6 provides a method in accordance with an exemplary embodiment. Although simplified, the steps here enable rate of decay measurements which may be used to adjust flow rate. As shown, the initial step 610 comprises providing a main flow path having an inlet valve, a shutoff valve, at least one transducer and a reduced flow path located downstream from the inlet valve. The inlet valve may be closed, per step 620, to initiate the decay of gas flow which is calculated in step 630 using pressure data from the reduced flow path. In particular, the reduced flow path may comprise a flow restrictor where the flow rate adjustment is desirable. The rate of decay calculated is then compared with the desired flow rate in step 640. The shutoff valve is then adjusted based on the comparison to adjust the flow rate in the reduce flow path, as provided in step 650. For instance, the shut off valve may be opened momentarily to increase flow as needed.

In another embodiment, methods and apparatus for a dual flow path with dual outlets mass flow controller. A gaseous liquid flowing through a mass flow controller is partitioned at the exit to follow a dual flow path. The gaseous liquid exiting is partitioned in a ratio ranging between 2%, 3%, 4%, 5%, 6%, 7%, 8% and 9% of the original flow through a narrower flow path with a narrower tube that may be, but is not limited to, hagen-poisulle tube, a thermal sensor. As shown in FIGS. 1 and 2, a secondary smaller flow path that is configured to flow parallel to the larger flow path may be used during reduced flow scenarios. As shown in FIG. 2 the reduced flow path may be used when the MFC receives a request to transfer at a rate less than 9% of full specification. The larger flow path may not be used until there is a setpoint larger than or equal to 10% of full specification.

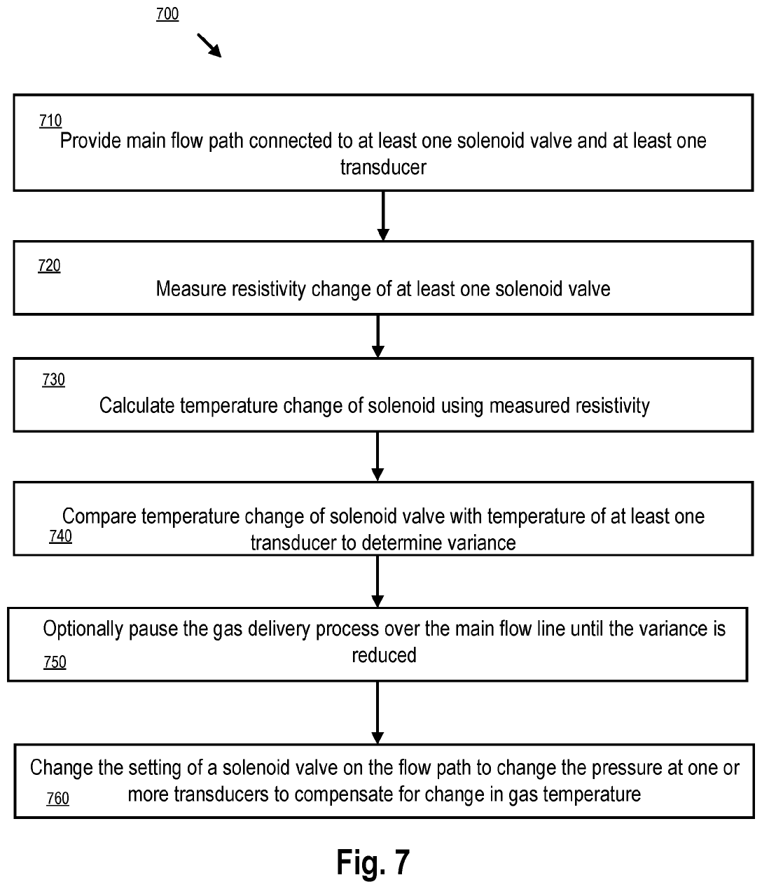

Referring to FIG. 7, FIG. 7 illustrates a method 700 in accordance with an exemplary embodiment. At step 710, the system provides a main flow path connected to at least one solenoid valve and at least one transducer. At step 720, the control module from the mass flow controller may measure resistivity change of at least one solenoid valve. In some embodiments, the change in resistivity may be indicative of the change in temperature of the solenoid and appropriate actions may be taken to change the pressure of the gas to address the temperature change which maintaining the flow rate. At step 730, the control module may calculate the temperature change of solenoid using the measured resistivity. At step 740, the control module may compare the temperature change of solenoid valve or flow path with temperature measured by at least one transducer to determine variance. At step 750, the control module circuitry may optionally pause the gas delivery process over the main flow line until the variance is reduced. At step 760, the control module may change the setting of a solenoid valve on the flow path to change the pressure at one or more transducers to compensate for change in gas temperature.

In other embodiments, the method 700 in FIG. 7 may be modified as follows. Various embodiments are directed to determining the temperature variances in a fluid flow path, in order to determine the variance in the transducer measured temperature compared to the temperature measured in the solenoid since solenoids can get heated in operations. Exemplary embodiments disclose a method of determining the temperature of the solenoid by using the change in resistivity of the metal in the solenoid. The solenoid may be composed of a material that exhibits a change in resistivity based on a change in temperature. Various materials exhibit the above stated properties, for example, copper, alloys, hastealloy, etc.

In other embodiments, the method 700 in FIG. 7 may be modified as follows. In various embodiments, upon determining a variance between the solenoid temperature that may be located upstream or downstream from a temperature measuring transducer, the gas deliver process may be modified. Some modifications of the gas delivery process may include changing the setting of another solenoid in the flow path to change the pressure at one or more transducers in order to compensate for the change in temperature of the gas. In some embodiments, the gas delivery process may be paused until the temperature variance is reduced. A non-limiting example of such a method is provided in the flow diagram of FIG. 7, steps 710-760. Thus in an exemplary embodiment, based on the known coefficient of resistivity of the metal at a given temperature (for example, room temperature) which maybe provided by the manufacturer and stored in the information storage, obtained from literature or measured, the change in the resistance of the solenoid may be used determine the temperature of the solenoid. The relationship between voltage, resistance and current may be used to perform this type of calculation. For instance, at a first temperature (T1) the resistance (R1) is equal to the voltage (V1) divided by the current (I1). At another temperature (T2) the Resistance (2) is again voltage (V2) divided by current (I2). R1 may be measured at the factory while R2 calculated in the field by measuring V2 and I2. Accordingly, the change in the resistivity (Δr) is the change in temperature (ΔT) multiplied by the thermal coefficient of resistance of the solenoid (e.g. Copper ˜0.4%/° C.). Accordingly, in some embodiments, the resistance is measure to have changed by 2%, then the temperature may have changed by 5° C. In some embodiments, a precalculated temperature to change in resistance calibration curve may be stored in the information storage so that it is efficient to determine the change in the temperature.

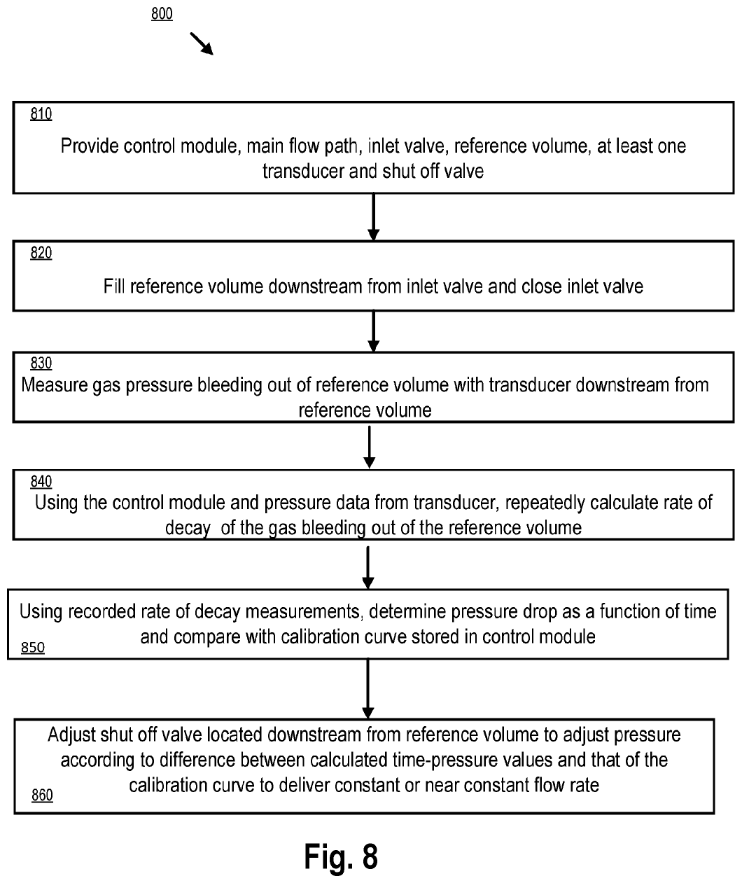

Referring to FIG. 8, FIG. 8 illustrates a method 800 in accordance with an exemplary embodiment. At step 810, the system provides a control module, a main flow path, an inlet valve, a reference volume, at least one transducer and a shut off valve. At step 820, the control module from the mass flow controller may fill reference volume downstream from the inlet valve and close the inlet valve. At step 830, the control module may measure the gas pressure bleeding out of the reference volume with the transducer downstream from reference volume. At step 840, using the control module and pressure data from transducer, repeatedly calculate rate of decay of the gas bleeding out of the reference volume. At step 850, the control module using the recorded rate of decay measurements, the control module may determine pressure drop as a function of time and compare with calibration curve stored in control module. At step 860, the control module may adjust the shut off valve located downstream from reference volume to adjust pressure according to difference between calculated time-pressure values and that of the calibration curve to deliver constant or near constant flow rate.

Having thus described several aspects of at least various embodiments of this system, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A method, comprising:
providing a main fluid flow path connected to a flow restrictor, an inlet valve connected to the flow path, and at least one transducer downstream from the inlet valve and connected to the main flow path, a shut off valve located downstream from the inlet valve and connected to the main flow path, and a control module;
calculating with the control module flow rate from the pressure signal from the at least one transducer when the inlet valve is closed; and
adjusting the shut off valve to adjust the flow rate through the flow restrictor.

2. The method of claim 1, comprising using the control module to continuously shut the inlet valve to calculate a rate of decay of fluid flow.

3. The method of claim 2, further comprising using the control module to adjust the shutoff valve based on the rate of decay calculations to adjust the flow to a preset flow value.

4. The method of claim 1, further comprising providing a reduced flow path connected to the main flow line downstream from the inlet valve.

5. The method of claim 3, further comprising using the control module to calculate rate of decay of fluid flow along the reduced flow path and adjusting the shutoff valve to adjust fluid flow based on the calculations and a preset flow value.

6. The method of claim 1, comprising using the control module to measure the resistance change of a solenoid component of the inlet or shutoff valve over at least one time interval to calculate the change in temperature of the solenoid.

7. The method of claim 6, further comprising using the control module to compare the temperature change of the solenoid with the temperature change data from a transducer adjacent to the solenoid, and determine the difference in reported temperatures.

8. The method of claim 7, further comprising applying a correction value to the transducer recorded temperature based on the difference with the solenoid temperature.

9. A system, comprising:
a main fluid flow path connected to a flow restrictor;
an inlet valve connected to the flow path;
at least one transducer located downstream from the inlet valve and connected to the main flow path;
a shut off valve, located downstream from inlet valve and connected to the main flow path; and
a control module configured to calculate flow rate from the pressure signal from the at least one transducer when the inlet valve is closed and adjust the shut off valve to adjust the flow rate through the flow restrictor.

10. The system of claim 9, comprising a reduced fluid flow path.

11. The system of claim 10, wherein the reduced fluid flow path is connected to a flow restrictor.

12. The system of claim 9, wherein the inlet valve, the shutoff valve, or both comprise solenoid valves.

13. The system of claim 9, wherein the control module comprises a long rate of decay sub-module configured to continuously calculate flow rate based on the at least one transducer pressure signals and compare said signals to a preset flow value.

14. The system of claim 10, wherein the control module comprises a long rate of decay sub-module configured to continuously calculate flow rate based on the at least one transducer pressure signals and compare said signals to a preset flow value along the reduced flow path.

15. The system of claim 9, wherein the control module is configured to continuously shut the inlet valve to calculate a rate of decay.

16. The system of claim 14, wherein the control module is configured to shut the inlet valve, measure the rate of decay along the reduced flow path, and adjust the shutoff valve, every 50-300 milliseconds.

17. The system of claim 13, wherein the control module continuously calculates rate of decay based on the at least one transducer signal and the pressure at the flow restrictor.

18. The system of claim 9, wherein the control module is configured to measure the resistance change of the solenoid component of the inlet or shutoff valve over at least one time interval to calculate the change in temperature of the solenoid.

19. The system of claim 18, wherein the control module is configured to compare the temperature change of the solenoid with the temperature change data from a transducer adjacent to the solenoid, and determine the difference in reported temperatures.

20. The system of claim 19, further comprising applying a correction value to the transducer recorded temperature based on the difference with the solenoid temperature.
